(19) United States
(12) Patent Application Publication
(10) Pub. No.: US 2009/0061409 A1
(43) Pub. Date: Mar. 5, 2009

(54) DEVICE AND METHOD FOR ARRANGING LEARNING COURSES

(75) Inventors: Ming Hsiang Yen, Jung-He City (TW); Jui Yu Yen, Taipei Hsien (TW); Kuang Chien Kao, Jung-He City (TW)

Correspondence Address: APEX JURIS, PLLC, 12733 LAKE CITY WAY NORTHEAST, SEATTLE, WA, 98125, US

(73) Assignee: MICRO-STAR INT'L CO., LTD., Jung-He City (TW)

(21) Appl. No.: 12/180,217

(22) Filed: Jul. 25, 2008

Related U.S. Application Data
(60) Provisional application No. 60/968,353, filed on Aug. 28, 2007.

(51) Int. Cl. G09B 7/00

(52) U.S. Cl. 434/362

(57) ABSTRACT

A device and method is provided for a user to arrange learning courses. The device comprises: a course database, a capability examining module and a course arranging module. The course database stores multiple learning courses, each including multiple learning quizzes. The capability examining module provides capability examination(s) for the user to determine the user's current capability level. The course arranging module acquires the corresponding learning courses from the course database according to the capability level determined by the capability examining module, and arranges these acquired corresponding learning courses for the user to learn.

### CROSS-REFERENCES TO RELATED APPLICATIONS

This application is a non-provisional application of the U.S. provisional application Ser. No. 60/968,353, entitled “Interactive Learning System” filed on Aug. 28, 2007.

### FIELD OF INVENTION

The present invention relates to a learning device and relevant method, and more particularly to a device and method for arranging learning courses.

### BACKGROUND

In recent years many portable devices equipped with learning functions have become commercially available. Language learning devices for example, are one of the learning devices the public uses most commonly. One very common device of this kind is an electronic dictionary. As well as being useful for looking up vocabulary, electronic dictionaries currently available in the market also provide a restudy function to help user repeatedly review certain Chinese or English vocabularies after looking them up. This helps the user to become familiar with the vocabulary, and memorize it.

A relevant TW patent application is “Portable Learning Device for Language Vocabulary”, Application No. 82207657. In this patent application, a learning device for language vocabulary is disclosed to repeatedly display vocabulary on a screen, so as to increase the opportunity to learn and memorize the vocabulary. Since the vocabulary stored in the learning device is specific, the user can easily use it without complex input through the keyboard. To test the user's learning progress, a simple button is provided to enter a test stage; the display probability of said vocabulary in the next stage is reduced according to the test result. Therefore, the probability of learned vocabulary being displayed again will fall, and un-memorized vocabulary has a greater opportunity for display.

Another relevant TW patent application is “Restudy system and Method for Vocabulary Selecting with Multimedia Aids”, Application No. 92107412. This patent application is used on an electronic dictionary. When the user is performing the vocabulary learning function, a list of vocabulary will be generated according to a weighted ranking of a learning evaluation result. When the vocabulary selection-restudy function is selected, the electronic dictionary will acquire and display one word in the list of learning vocabulary, as well as multimedia information (such as voices, pictures, animations) corresponding to the word. The user's memory of the word will thus be strengthened to achieve the objective of vocabulary selection and restudy.

However, conventional technology and the relevant patents mentioned above still have the following problems:

(1) In conventional technology, when the user is using learning functions, no level-analysis is applied to the user to discern an appropriate learning course according to the user's current capability level.

(2) The learning courses are programmed as the system default. Alternatively, the frequency of the provided courses (or vocabulary) is determined according to the user's examination results of post quizzes. Therefore, the user is not able to set up the course schedule based on personal actual needs, such as how much new or old vocabulary needs to be reviewed every day.

Hence, the solution of the problems of the aforesaid learning device and enhancement of the user's learning efficiency is a critical issue as yet unreached.

### SUMMARY OF THE INVENTION

To solve the aforesaid technical problems in the prior art, the present invention provides a device and method for arranging learning. Initially the user's current level will be determined first to choose an appropriate learning course. As to course arrangement, aside from using the system default courses the user is able to determine the course schedule based on the user's actual needs, thereby greatly enhance the users' learning efficiency.

In an embodiment according to the present invention, a device is provided for a user to arrange a personalized learning schedule. The device comprises: a course database, a capability examining module and a course arranging module. The course database stores multiple learning courses, each including multiple learning quizzes. The capability examining module provides a capability examination(s) for the user to determine the user's current capability level. The course arranging module acquires the corresponding learning courses from the course database according to the capability level determined by the capability examining module, and arranges acquired corresponding learning courses for the user to learn.

In another embodiment according to the present invention, a learning arrangement method includes the following steps. First, plural learning courses are stored, each having multiple learning quizzes. Next, a capability examination for a user to determine a current capability level of the user is provided. Finally, learning courses corresponding to the current capability level of the user are acquired and arranged for the user.

These and other features, aspects, and advantages of the present invention will become better understood with reference to the following description and appended claims. It is to be understood that both the foregoing general description and the following detailed description are examples, and are intended to provide further explanation of the invention as claimed.

### BRIEF DESCRIPTION OF THE DRAWINGS

The present invention can be more fully understood by reference to the following description and accompanying drawings, in which:

FIG. 1 is an explanatory block diagram of a device for arranging learning courses according to a first preferred embodiment of the present invention;

FIG. 2 is an explanatory block diagram of another device for arranging learning courses according to a second preferred embodiment of the present invention;

FIG. 3 is an explanatory diagram of learning courses according to a preferred embodiment of the present invention; and

FIG. 4 is an explanatory flow chart of a learning arrangement method according to a preferred embodiment of the present invention.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description refers to the same or the like parts.

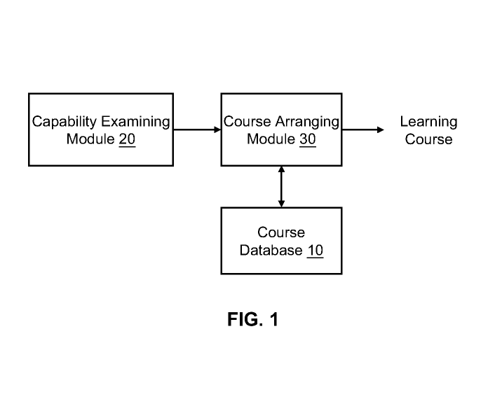

Please refer to FIG. 1, which is an explanatory block diagram of a device for arranging learning courses according to a first preferred embodiment of the present invention. The device for arranging learning courses mainly includes a course database 10, a capability examining module 20 and a course arranging module 30.

The course database 10 stores multiple learning courses. Every learning course may include multiple learning quizzes. Various types of learning courses such as multinational languages, multinational histories, multinational geographies and math, are stored in the course database 10 to fulfill the different needs of different users. In addition, to meet the different needs of every user, the device for arranging learning courses of the present invention enables the user to add new learning course(s) based on their actual needs and to store them in the course database 10. Therefore, even though the original course database 10 does not store the user's desired learning courses in the beginning, the user can still add new learning course(s) based on their actual needs and to store in the course database 10, for subsequent learning.

Before the device for arranging learning courses of the present invention organizes the learning courses for the user, the capability examining module 20 will be used first to provide a capability examination for the user and determine the user's current capability level. Pre-examining the user's current capacity level before organizing the learning course(s) by means of the capability examining module 20, will make subsequently organized learning course(s) more suitable to the user's capability, thereby improving learning efficiency.

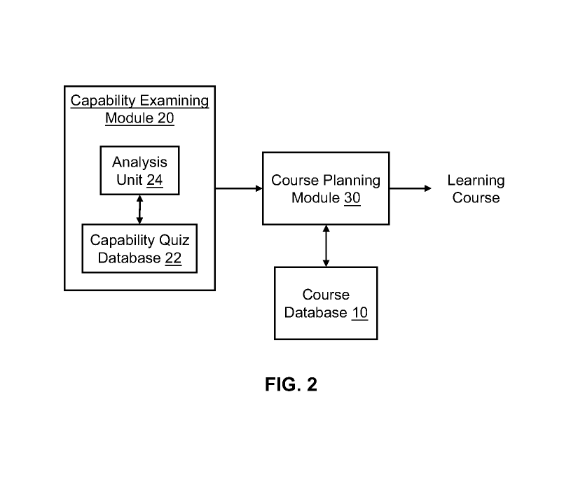

Please refer to FIG. 2, which is an explanatory block diagram of another device for arranging learning courses according to a second preferred embodiment of the present invention; wherein the capability examining module 20 mainly includes a capability quiz database 22 and an analysis unit 24.

To examine the user's current capability level, the capability quiz database 22 stores plural capability quizzes corresponding to each of the capability levels. For example, from Elementary School Third Grade to University Fourth Grade, every grade may be considered a single capability level. Thus there are total fourteen capability levels from Elementary School Third Grade to University Fourth Grade. Such an example is only for explanation purposes and should not be understood as any limitation to the present invention.

The analysis unit 24 acquires a specific capability quiz from the capability quiz database 22 according to an initial level to examine the user; wherein the initial level may be a system default or determined by the user. A method for examining the user's current capability level according to the present invention is that the analysis unit 24 first acquires a capability quiz corresponding to the initial level, and then, if the user answers the capability quiz “correctly”, the analysis unit 24 increases the level grade and acquires another one of the capability quizzes higher than the current capability level to reexamine the user; if the user answers the capability quiz “incorrectly”, the analysis unit decreases the level grade and acquires another capability quiz lower than the current one of the capability levels to reexamine the user. The steps disclosed above will be repeated until the level grade reaches a threshold grade. When the user answers the capability quizzes continuously and finally the user's accumulated level grade reaches the threshold grade, the user will be recognized at the current capability level. Furthermore, while examining the user's current capability level, if the user abandons the capability quiz the level grade will not be changed; it will remain the same. Another capability quiz with a lower capability level will be acquired to reexamine the user.

After determine the user's current capability level through the capability examining module 20, the course arranging module 30 acquires from the course database 10 learning courses corresponding to the current capability level of the user determined by the capability examining module 20, and organizes the acquired corresponding learning courses for the user to learn. The learning courses arranged by the course arranging module 30 may include three sections: a new quiz section, a review quiz section and a fault quiz section. The new quiz section includes those learning quizzes that are unlearned (not finished, not used or not selected) by the user. The review quiz section includes those learning quizzes that are learned (finished or answered correctly) by the user. The fault quiz section includes those learning quizzes that the user repeatedly answers incorrectly.

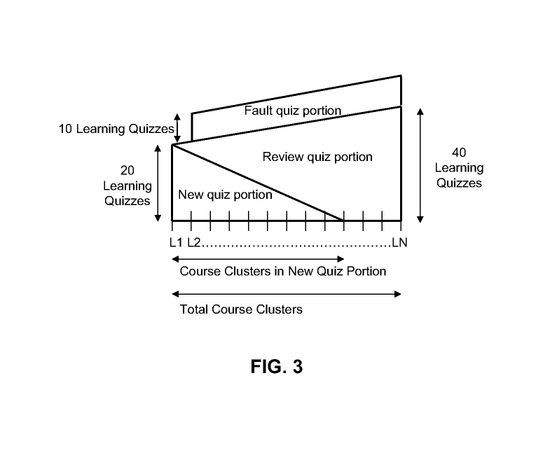

Please refer to FIG. 3, which is an explanatory diagram of learning courses according to a preferred embodiment of the present invention. Here language learning is used as an example to explain the learning courses organized by the course arranging module 30. Assume the course arranging module 30 arranges a specific learning course having 200 words. The new quiz section includes 200 words (namely 200 learning quizzes). If every word needs to be reviewed twice, then the review quiz section will include 400 learning quizzes. The number of review times may be determined by the user and is not limited to two.

The course arranging module 30 will organize the acquired learning courses into at least one course cluster. The course cluster may possibly include the learning quizzes selected from the group consisting of the new quiz section, the review quiz section, the fault quiz section and a combination of said quiz sections. For example, the course arranging module 30 divides the acquired learning courses into N course clusters L1, L2 . . . LN (Lesson 1, Lesson 2 . . . . Lesson N); where the number of course clusters selected from the acquired learning courses may be determined by the user.

As shown in FIG. 3, the course cluster L1 (Lesson 1) includes the maximum new words (20 learning quizzes). As the amount of course clusters increases, the number of new words to be memorized will decrease; yet the number of words (learning quizzes) which need to be reviewed will increase. Thus, as the amount of course clusters increases, the course arranging module 30 decreases the learning quizzes involved in the new quiz section, and increases the learning quizzes involved in the review quiz section.

Moreover, the learning quizzes involved in the new quiz section plus the learning quizzes involved in the review quiz section are not less than twenty learning quizzes and not more than forty learning quizzes. The amount of the learning quizzes involved in every course cluster may be determined by the user. Therefore, the user may decide how many quizzes should be learned according to their personal capability and study habits. The number of new words involved and old words reviewed in every course cluster may also be determined by the user according to their needs, thereby enhance the user's learning efficiency.

Please continue to refer to FIG. 3. Above the new quiz section and the review quiz section, there is a fault quiz section reserving 10 learning quizzes (words) every day (the amount of the learning quizzes reserved in the fault quiz section may be determined according to the user's needs). These 10 words are the words that the user repeatedly answers incorrectly. When a new learning course is opened, the 10 words arranged into the fault quiz section may be selected randomly from the learned new words. Subsequently, a post quiz is provided after every course cluster and those words (quizzes) that the user repeatedly answers incorrectly are recorded in the fault quiz section. The user will be able to strengthen their weaker language area(s) according to their actual learning status.

Furthermore, at the lower area of FIG. 3, the amount of the course clusters involved in the new quiz section is about 0.8 times (not limited) the total course clusters. This design is intended to reserve some learning courses for reviewing old words (quizzes) instead of new words. Thus, all the arranged new words will be finished before the last learning courses, so in the last learning courses the user may review old words (quizzes) and strengthen their memory to increase learning efficiency.

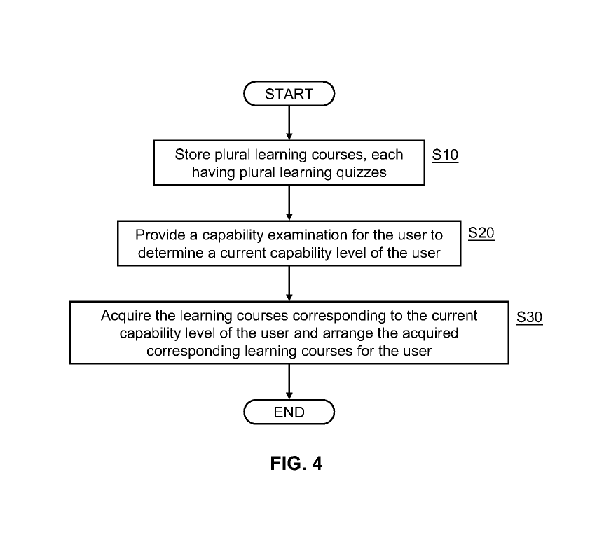

Please refer to FIG. 4, which is an explanatory flow chart of a learning arrangement method according to a preferred embodiment of the present invention. The learning arrangement method includes the following steps.

Step S10: Store multiple learning courses, each having multiple learning quizzes. The involved learning courses include various items and are not limited to any certain types. Meanwhile the learning courses may be added according to the user's needs.

Step S20: Provide a capability examination for the user to determine the current capability level of the user; wherein the step of capability examination further includes: store multiple capability quizzes corresponding to every capability level; and acquire the capability quizzes corresponding to the initial level to examine the user; wherein the initial level may be determined by the user.

The step of capability examination in the aforesaid Step S20 further includes the following steps: if the capability quiz is answered correctly, increase the level grade and acquire the capability quiz with a capability level higher than the current one to reexamine the user; if the user answers the capability quiz wrong, decrease the level grade and acquire the capability quiz with a capability level lower than the current one to reexamine the user. The above two steps will be repeated until the level grade achieves a threshold grade.

Step S30: Acquire the learning course corresponding to the current capability level of the user and arrange the acquired corresponding learning course for the user. The step of arranging the learning courses includes: arrange a new quiz section including the learning quizzes unlearned by the user; arrange a review quiz section including the learning quizzes learned by the user; and arrange a fault quiz section including the learning quizzes that the user answers incorrectly and repeatedly.

Divide the learning courses into at least one course cluster, wherein the course cluster includes the learning quizzes selected from the group consisting of the new quiz section, the review quiz section, the fault quiz section and a combination of said quiz sections. As the amount of the course clusters increases, decrease the amount of the learning quizzes involved in the new quiz section and increase the amount of learning quizzes involved in the review quiz section. The amount of learning quizzes involved in each of the course clusters may be determined by the user.

Additional advantages and modifications will readily occur to those proficient in the relevant fields. The invention in its broader aspects is therefore not limited to the specific details and representative embodiments shown and described herein. Accordingly, various modifications may be made without departing from the spirit or scope of the general inventive concept as defined by the appended claims and their equivalents.

What is claimed is:

1. A device for arranging learning courses, comprising:
a course database, storing a plurality of learning courses, each of the learning courses comprising a plurality of learning quizzes;
a capability examining module, providing a capability examination for a user to determine a current capability level of the user; and
a course arranging module, acquiring from the course database at least one of the learning courses corresponding to the current capability level of the user determined by the capability examining module, and organizing the acquired corresponding learning courses for the user.

2. The device of claim 1, wherein the capability examining module comprises:
a capability quiz database, storing a plurality of capability quizzes corresponding to each of a plurality of capability levels; and
an analysis unit, acquiring from the capability quiz database the corresponding capability quizzes according to an initial level to examine the user.

3. The device of claim 2, wherein the analysis unit increases a level grade and acquires another level quiz higher than the current capability level when the user answers the level quiz correctly, and when the user answers the level quiz incorrectly the analysis unit decreases the level grade and acquires another level quiz lower than the current one of the capability levels to reexamine the user until the level grade reaches a threshold grade.

4. The device of claim 1, wherein a new learning course may be added by the user and stored in the course database.

5. The device of claim 1, wherein the learning course comprises:
a new quiz section, including at least one of the learning quizzes unlearned by the user;
a review quiz section, including at least one of the learning quizzes learned by the user; and
a fault quiz section, including at least one of the learning quizzes that the user repeatedly answers incorrectly.

6. The device of claim 5, wherein the course arranging module organizes the acquired corresponding learning courses into at least one course cluster, the course cluster comprising the learning quizzes selected from the group consisting of the new quiz section, the review quiz section, the fault quiz section and a combination of said quiz sections.

7. The device of claim 6, wherein the course arranging module decreases the amount of the learning quizzes involved in the new quiz section as the amount of the course clusters increases, and the course arranging module increases the amount of the learning quizzes involved in the review quiz section when the amount of the course clusters increases.

8. The device of claim 6, wherein the amount of the learning quizzes involved in the course cluster may be determined by the user.

9. A method for arranging learning courses, comprising the steps of:
storing a plurality of learning courses, each having a plurality of learning quizzes;
providing a capability examination for the user to determine a current capability level of the user; and
organizing the learning courses corresponding to the current capability level of the user and arranging the acquired corresponding learning courses for the user.

10. The method of claim 9, wherein the step of capability examination comprises:
storing a plurality of capability quizzes corresponding to each of the capability levels;
acquiring the capability quiz according to a initial level to examine the user;
increasing a level grade and acquiring the capability quizzes with another capability level higher than the current capability level if the capability quizzes are answered correctly;
decreasing the level grade and acquiring the capability quizzes with another capability level lower than the current capability if the capability quizzes are answered incorrectly; and
reexamining the user until the level grade achieves a threshold grade.

11. The method of claim 9, wherein the step of organizing the learning courses comprising:
arranging a new quiz section including at least one of the learning quizzes unlearned by the user;
arranging a review quiz section including at least one of the learning quizzes learned by the user;
arranging a fault quiz section including at least one of the learning quizzes that the user answers incorrectly and repeatedly; and
dividing the learning courses as at least one course cluster, the course cluster comprising the learning quizzes selected from the group consisting of the new quiz section, the review quiz section, the fault quiz section and a combination of said quiz sections.

12. The method of claim 9 further comprising the step of: decreasing the learning quizzes involved in the new quiz section and increasing the learning quizzes involved in the review quiz section as the amount of the course clusters increases.
